(19) United States
(12) Patent Application Publication
(10) Pub. No.: US 2025/0364648 A1
(43) Pub. Date: Nov. 27, 2025

(54) SECONDARY BATTERY AND METHOD OF MANUFACTURING SECONDARY BATTERY

(71) Applicant: SAMSUNG SDI CO., LTD., Yongin-si (KR)

(72) Inventor: Jeawoan LEE, Yongin-si (KR)

(21) Appl. No.: 18/942,904

(22) Filed: Nov. 11, 2024

(30) Foreign Application Priority Data
May 24, 2024 (KR) 10-2024-0068132

(51) Int. Cl. H01M 50/172; H01M 50/169; H01M 50/46; H01M 50/533; H01M 50/566; H01M 50/591; H01M 50/593; H01M 50/595

(52) U.S. Cl. CPC H01M 50/172; H01M 50/169; H01M 50/46; H01M 50/533; H01M 50/566; H01M 50/591; H01M 50/593; H01M 50/595

(57) ABSTRACT

A secondary battery includes an electrode assembly including a first electrode plate on which a first current collection tab is formed and a second electrode plate on which a second current collection tab is formed. A case accommodates the electrode assembly. A cap assembly is formed at a side of the case. An insulating member is disposed between the cap assembly and the electrode assembly. The first current collection tab is directly connected to an electrode terminal that passes through the cap assembly. At least one of the first current collection tab and the second current collection tab passes through the insulating member.

### CROSS-REFERENCE TO RELATED APPLICATION

The present application claims priority to and the benefit of Korean Application No. 10-2024-0068132, filed on May 24, 2024, in the Korean Intellectual Property Office, the entire disclosure of which is incorporated by reference herein.

### BACKGROUND

### Technical Field

Aspects of embodiments of the present disclosure relate to a secondary battery and a method of manufacturing the secondary battery.

### Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Research is actively being conducted to improve the quick charging and capacity of secondary batteries. To meet the demand for quick charging technology for secondary batteries, a method of applying a current collection tab in which base tabs of secondary batteries are joined into one body has been developed. However, when using such a current collection tab, the space required to connect a current collection tab to a terminal reduces space for battery capacity, which is disadvantageous.

The above information disclosed in this Background section is for enhancement of understanding of the background of the present disclosure, and therefore, it may contain information that does not constitute related (or prior) art.

### SUMMARY

To solve the problems described above, aspects of embodiments of the present disclosure provide a secondary battery and a method of manufacturing the secondary battery.

These and other aspects and features of the present disclosure will be described in or will be apparent from the following description of embodiments of the present disclosure.

According to some embodiments of the present disclosure, there is provided a secondary battery including: an electrode assembly that includes a first electrode plate on which a first current collection tab is formed and a second electrode plate on which a second current collection tab is formed, a case accommodating the electrode assembly, a cap assembly formed at a side of the case; and an insulating member disposed between the cap assembly and the electrode assembly, wherein the first current collection tab is directly connected to an electrode terminal formed that passes through the cap assembly, at least one of the first current collection tab and the second current collection tab passes through the insulating member, and the case is formed of stainless steel.

In some embodiments, the second current collection tab is directly connected to the case, and the first current collection tab and the second current collection tab pass through the insulating member.

In some embodiments, an opening is formed in the case on a side that is perpendicular to the side where the cap assembly is formed, and the electrode assembly is inserted into the case through the opening.

In some embodiments, the first electrode plate includes a plurality of the first electrode plate and a plurality of first base tabs protruding toward a side of the first electrode plates, the second electrode plate includes a plurality of the second electrode plate and a plurality of second base tabs protruding toward one side of the second electrode plates, the first current collection tab is formed by joining the first base tabs, and the second current collection tab is formed by joining the second base tabs.

In some embodiments, the insulating member comprises a first through-hole and a second through-hole, the first current collection tab passes through the insulating member via the first through-hole, and the second current collection tab passes through the insulating member via the second through-hole.

In some embodiments, the first through-hole and the second through-hole are disposed side-by-side and spaced apart from each other in a first direction, and the first through-hole and the second through-hole are disposed more towards one side with respect to a center line in a second direction that is perpendicular to the first direction.

In some embodiments, an adhesive layer coated is formed on one surface of the insulating member, and the insulating member and the electrode assembly are bonded to each other by the adhesive layer.

In some embodiments, the insulating member has a third through-hole for injection of an electrolyte into the case.

In some embodiments, the secondary battery further includes a case cover joined to the case and sealing the opening; and a protection tape attached to one surface of the electrode assembly and facing the case cover.

In some embodiments, the protection tape protrudes from the electrode assembly in a direction that the first current collection tab protrudes from the electrode assembly.

In some embodiments, the secondary battery further includes a case cover joined to the case and sealing the opening; and a protection tape attached to a surface of the case cover and facing the electrode assembly.

In some embodiments, the electrode assembly further comprises separators, and the electrode assembly is formed by alternately stacking a plurality of the first electrode plate and a plurality of the second electrode plate with the separators between each adjacent first plate and the second plate.

According to some embodiments of the present disclosure, there is provided a method of manufacturing a secondary battery including: preparing an electrode assembly comprising a first electrode plate on which a first current collection tab is formed and a second electrode plate on which a second current collection tab is formed; inserting the first current collection tab through a first through-hole formed in an insulating member so that the first current collection tab passes through the insulating member; inserting the second current collection tab through a second through-hole formed in the insulating member so that the second current collection tab passes through the insulating member; directly connecting the first current collection tab to an electrode terminal provided on the cap assembly; directly connecting the second current collection tab to a case; accommodating the electrode assembly in the case; and joining a case cover to the case by welding to thereby seal the case.

In some embodiments, the preparing of the electrode assembly includes: forming the first current collection tab by joining a plurality of first base tabs protruding from a side of the first electrode plate; and forming the second current collection tab by joining a plurality of second base tabs protruding from a side of the second electrode plate.

In some embodiments, the cap assembly is formed at a side of the case, an opening is formed in a side of the case that is perpendicular to the side where the cap assembly is formed, and the electrode assembly is inserted into the case through the opening.

In some embodiments, the direct connecting of the first current collection tab to the electrode terminal provided on the cap assembly includes disposing the first current collection tab on the electrode terminal.

In some embodiments, the direct connecting of the second current collection tab to the case includes disposing the second current collection tab on the surface of the case.

In some embodiments, the accommodating of the electrode assembly in the case includes rotating the electrode assembly in to the case, with the first current collection tab and the second current collection tab being bent as the electrode assembly is rotated.

In some embodiments, the method further includes bonding the insulating member to the electrode assembly before accommodating of the electrode assembly in the case.

In some embodiments, the electrode assembly further includes separators, and the electrode assembly is formed by alternately stacking a plurality of the first electrode plate and a plurality of the second electrode plate with the separators between each adjacent first plate and the second plate.

According to some embodiments of the present disclosure, the first electrode tab is directly connected to the electrode terminal and the second current collection tab is directly connected to the case, thereby omitting a strip terminal. Accordingly, the space for the electrode assembly or the electrolyte is expanded by the space where the strip terminal would have been provided, which is advantageous in terms of battery capacity.

According to some embodiments of the present disclosure, the protection tape prevents the first current collection tab and/or the second current collection tab, which are bent during the process of accommodating the electrode assembly in the case, from contacting the case or the case cover, thereby short-circuits.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a cross-sectional view of a secondary battery according to embodiments of the present disclosure.

FIG. 2 is a cross-sectional view of a secondary battery according to embodiments of the present disclosure.

FIG. 3 is a cross-sectional view of a secondary battery according to embodiments of the present disclosure.

FIG. 4 is a side view of the insulating member according to embodiments of the present disclosure.

FIG. 5 is a plan view of the insulating member according to embodiments of the present disclosure.

FIG. 6 is a plan view of an insulating member according to other embodiments of the present disclosure.

FIG. 7 is a diagram for describing a protection tape 740 according to embodiments of the present disclosure.

FIGS. 8 to 10 are diagrams for describing a method of manufacturing a secondary battery according to embodiments of the present disclosure.

FIG. 11 is a flowchart 1100 for describing a method of manufacturing a secondary battery according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

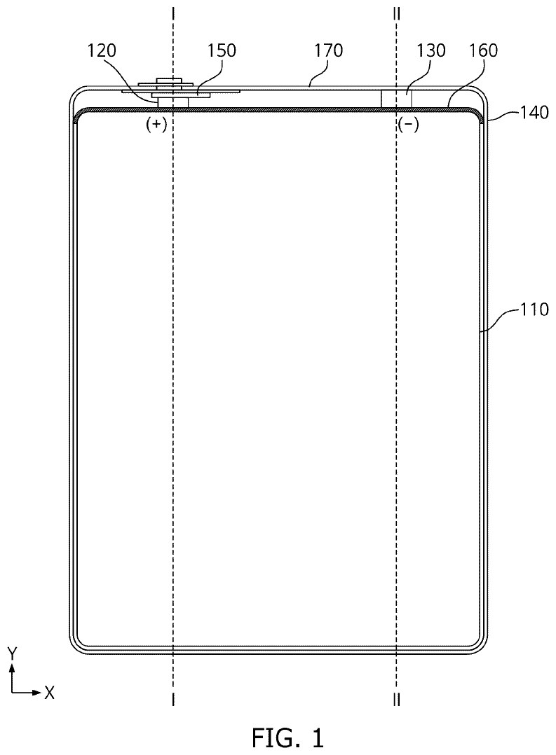

FIG. 1 is a cross-sectional view of a secondary battery according to embodiments of the present disclosure. Referring to FIG. 1, the secondary battery may include at least one electrode assembly 110 wound or stacked with a separator, which is an insulator, between a positive electrode plate and a negative electrode plate. The electrode assembly 110 is accommodated in a case 140, a cap assembly 170 is formed on one surface of the case 140, and an insulating member 160 is disposed between the cap assembly 170 and the electrode assembly 110.

The positive electrode plate and the negative electrode plate may include a coated portion, which is an area where an active material is applied to a current collector formed of a thin metal foil, and an uncoated portion, which is an area where no active material is coated.

According to embodiments, the positive electrode plate and the negative electrode plate may be stacked with the separator, which is an insulator, therebetween. For example, the electrode assembly 110 may have a structure in which the positive electrode plate and the negative electrode plate each including a plurality of sheets that are alternately stacked with the separator therebetween. However, the present disclosure is not limited thereto. For example, the electrode assembly 110 may include the positive electrode plate and the negative electrode plate wound with the separator therebetween.

The case 140 forms the overall outer appearance of the secondary battery. According to embodiments, the case 140 may be formed of stainless steel (SUS). Alternatively, the case 140 may be formed of a conductive metal, such as aluminum, aluminum alloy, or nickel-plated steel. In addition, the case 140 may provide a space in which the electrode assembly 110 is accommodated. The case 140 is depicted as a rectangular case and the secondary battery is a rectangular battery, but the scope of the present disclosure is not limited thereto. The secondary battery may have any shape, such as a rectangular shape, a cylindrical shape, or a pouch shape.

The case 140 may have an opening formed in one surface that is in perpendicular contact with a surface of the cap assembly 170. The case cover may be joined to the opening of the case 140 to seal the case 140. The case 140 and the cap assembly 170 may each be formed of a conductive material.

An electrode terminal may be formed in the cap assembly 170. A positive electrode terminal, a negative electrode terminal, an electrolyte injection port, and a vent portion may be formed in the cap assembly 170. The cap assembly 170 may include a cap plate. The cap plate may be formed as a plate separate from the case or may be formed integrally with the case. The cap plate may correspond to a portion of the case.

A positive electrode base tab electrically connected to a positive electrode uncoated portion may be formed on one side of the positive electrode plate, and a negative electrode base tab electrically connected to a negative electrode uncoated portion may be formed on one side of the negative electrode plate. The positive electrode base tab may be formed at a specific position on the side of the positive electrode plate, and the negative electrode base tab may be formed at a specific position on the side of the negative electrode plate.

The positive electrode base tab and the negative electrode base tab may be formed on one side of the electrode assembly 110 in the same direction. A plurality of positive electrode base tabs formed on a plurality of positive electrode plates may be joined to each other to form a first current collection tab 120. A plurality of negative electrode base tabs formed on a plurality of negative electrode plates may be joined to each other to form a second current collection tab 130.

The first current collection tab 120 and the second current collection tab 130 may be formed at different positions at a side of the electrode assembly 110. The first current collection tab 120 and the second current collection tab 130 may be spaced apart from each other by a certain distance in the first direction (X-axis). Accordingly, the first current collection tab 120 and the second current collection tab 130 may not be in contact with each other.

The first current collection tab 120 may be formed on one side of the electrode assembly 110, and the second current collection tab 130 may be formed on the other side of the electrode assembly 110. Thus, the first current collection tab 120 and the second current collection tab 130 may not be in contact with each other.

The insulating member 160 may be disposed on the electrode assembly 110. According to embodiments, an adhesive layer coated with an adhesive may be formed on one surface of the insulating member 160, and the insulating member 160 and the electrode assembly 110 may be bonded to each other by the adhesive layer.

The first current collection tab 120 and the second current collection tab 130 may pass through the insulating member 160. For example, the insulating member 160 may include a first through-hole and a second through-hole spaced apart from each other by a certain distance in the first direction (X-axis). The first through-hole and the second through-hole may be formed at positions corresponding to the first current collection tab 120 and the second current collection tab 130, respectively. The first current collection tab 120 may pass through the insulating member 160 by way of the first through-hole, and the second current collection tab 130 may pass through the insulating member 160 by way of the second through-hole.

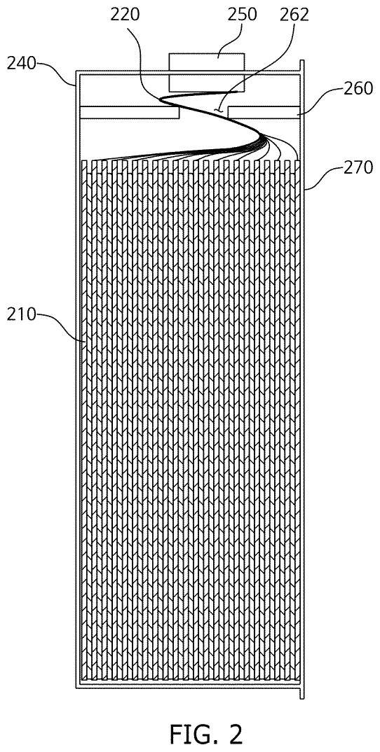

According to embodiments, the positive electrode plate may be electrically connected to the electrode terminal 150. Specifically, the first current collection tab 120 connected to the positive electrode plate may pass through the insulating member 160 and may be electrically connected to the electrode terminal 150. Thus, the electrode terminal 150 may be a positive electrode terminal. An example in which the first current collection tab 120 and the electrode terminal 150 are connected to each other is described in detail below with reference to FIG. 2.

The electrode terminal 150 electrically connected to the positive electrode plate may be joined to the cap assembly 170. For example, the electrode terminal 150 may be disposed to pass through the cap assembly 170 and protrude outward.

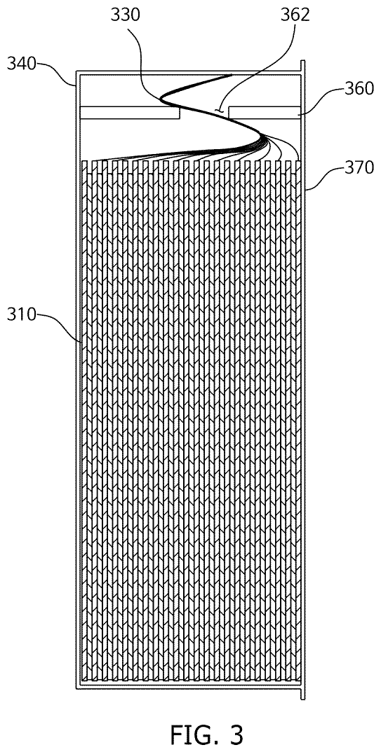

According to embodiments, the negative electrode plate may be electrically connected to the case 140, and the case 140 may have a negative polarity. The second current collection tab 130 connected to the negative electrode plate may pass through the insulating member 160 and may be electrically connected to the case 140. An example in which the second current collection tab 130 and the case 140 are connected to each other is described in detail below with reference to FIG. 3.

The secondary battery may be a lithium battery cell, a sodium battery cell, or the like. However, the scope of the present disclosure is not limited thereto, and the secondary battery may be any battery that is capable of repeatedly providing electricity through charging and discharging.

With this configuration, the first current collection tab 120 may be directly connected to the electrode terminal 150, and the second current collection tab 130 may be directly connected to the case 140. Accordingly, a strip terminal for connecting the first current collection tab 120 to the electrode terminal 150 and connecting the second current collection tab 130 to the case 140 may be omitted. Because the strip terminal is omitted, the space in the case 140 for the electrode assembly and/or the electrolyte is expanded, which is advantageous in terms of battery capacity.

The configuration of the secondary battery illustrated in FIG. 1 is only an example. Configurations other than those illustrated herein may be used. In addition, the shape, positional relationship, and the like of each component of the secondary battery illustrated in FIG. 1 may be changed as appropriate.

FIG. 2 is a cross-sectional view of a secondary battery according to embodiments of the present disclosure. In particular, FIG. 2 is a cross-sectional view of the secondary battery of FIG. 1 taken along line I-I.

The secondary battery may include an electrode assembly 210 in which a positive electrode plate, a negative electrode plate, and a separator are stacked, a case 240 in which the electrode assembly 210 is embedded, a cap assembly formed on one side of the case 240, and an insulating member 260 disposed between the electrode assembly 210 and the cap assembly.

The case 240 may be open on a side that is perpendicular to the cap assembly is. The opening may be sealed by the joining of the case 240 and the case cover 270.

A positive electrode base tab electrically connected to a positive electrode uncoated portion may be formed on one side of the positive electrode plate. The positive electrode base tab may be formed at a specific position on the side of the positive electrode plate. Accordingly, when the electrode assembly 210 is stacked, a plurality of positive electrode base tabs formed on a plurality of positive electrode plates may be disposed at positions that correspond to and overlap each other. The positive electrode base tabs may be joined to each other to form a first current collection tab 220.

The insulating member 260 may be disposed between the electrode assembly 210 and the cap assembly to electrically insulate the electrode assembly 210 from the case 240. According to some embodiments, an adhesive layer is coated on a surface of the insulating member 260. The insulating member 260 may be bonded to the electrode assembly 210 by the adhesive layer.

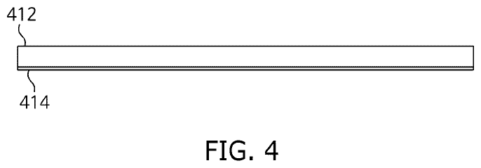

The insulating member 260 may include a first through-hole 262. The first current collection tab 220 may pass through the insulating member 260 via the first through-hole 262. An example of the insulating member 260 is described in detail below with reference to FIGS. 4 to 6.

The first current collection tab 220 may be connected to the cap assembly. Specifically, the first current collection tab 220 that passes through the insulating member 260 may be bent and directly connected to the electrode terminal 250 formed in the cap assembly. Here, the electrode terminal 250 may be a positive electrode terminal. The first current collection tab 220 and the electrode terminal 250 may be joined to each other by welding, but the present disclosure is not limited thereto.

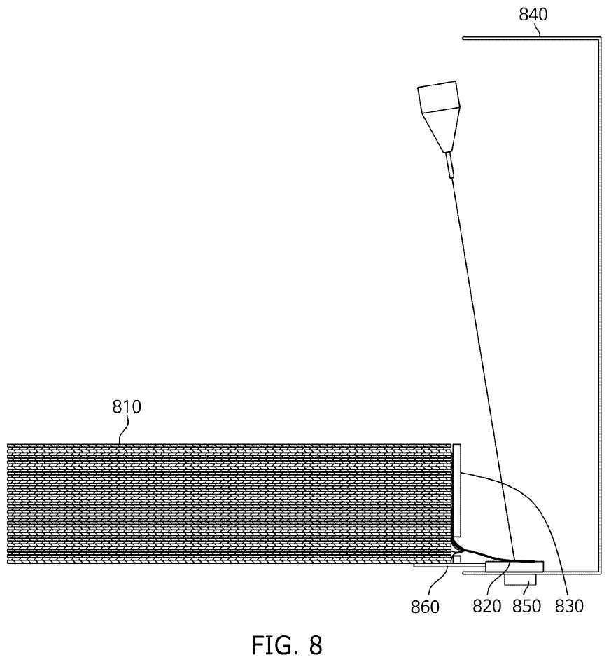

FIG. 2 illustrates that the first current collection tab 220 is bent in an approximate ‘S’ shape and connected to the electrode terminal 250. But the present disclosure is not limited to such a configuration. For example, the first current collection tab 220 may be bent approximately in a ‘C’ shape and connected to the electrode terminal 250. An example in which the first current collection tab 220 is bent and connected to the electrode terminal 250 is described in detail below with reference to FIG. 8.

FIG. 3 is a cross-sectional view of a secondary battery according to embodiments of the present disclosure. In particular, FIG. 3 is a cross-sectional view of the secondary battery of FIG. 1 taken along line II-II. In FIG. 3, configurations and components already described above with reference to FIG. 2 are omitted.

The secondary battery may include an electrode assembly 310 in which a positive electrode plate, a negative electrode plate, and a separator are stacked, a case 340 in which the electrode assembly 310 is embedded, a cap assembly formed on one side of the case 340, an insulating member 360 disposed between the electrode assembly 310 and the cap assembly, and a case cover 370 sealing the case 340.

A negative electrode base tab electrically connected to a negative electrode uncoated portion may be formed on one side of the negative electrode plate. The negative electrode base tab may be formed at a specific position on the side of the negative electrode plate. Accordingly, when the electrode assembly 310 is stacked, a plurality of negative electrode base tabs formed on a plurality of negative electrode plates may be disposed at positions that correspond to and overlap each other. The negative electrode base tabs may be joined to each other to form a second current collection tab 330.

The insulating member 360 may include a second through-hole 362. The second current collection tab 320 may pass through the insulating member 360 via the second through-hole 362 and may be connected to the case 340. Specifically, the second current collection tab 320 that passes through the insulating member 360 may be bent and directly connected to the inner surface of the case 340. The inner surface of the case 340 that is directly connected to the second current collection tab 320 may be a portion of the cap plate. The second current collection tab 320 and the case 340 may be joined to each other by welding, but the present disclosure is not limited thereto.

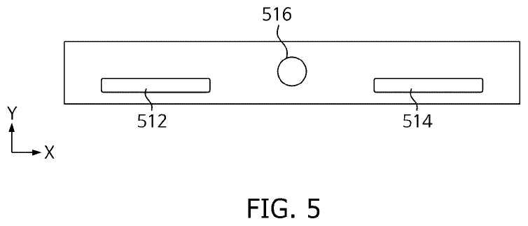

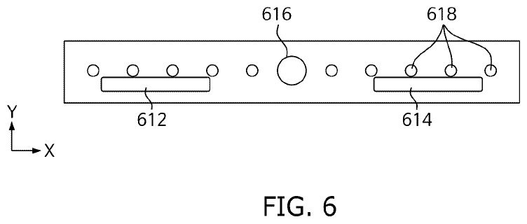

FIG. 4 is a side view of the insulating member according to embodiments of the present disclosure, FIG. 5 is a plan view of the insulating member according to embodiments of the present disclosure, and FIG. 6 is a plan view of an insulating member according to other embodiments of the present disclosure.

Referring to FIG. 4, the insulating member may include an insulating layer 412 and an adhesive layer 414 formed on one surface of the insulating layer 412. The insulating layer 412 may be formed of a material such as polypropylene (PP), polyethylene terephthalate (PET), polyether ether ketone (PEEK), or polyimide (PI), but the present disclosure is not limited to such examples. The adhesive layer 414 is an acrylate-based adhesive and may be formed of a material such as acrylate rubber or acrylate resin, but the present disclosure is not limited to such examples. The adhesive layer 414 may be bonded to a surface of the electrode assembly that faces the cap assembly.

Referring to FIG. 5, the insulating member may have a substantially rectangular shape. The insulating member may have a long side in the first direction (X-axis), but the present disclosure is not limited thereto. The insulating member may be formed in the shape and/or size corresponding to the cap assembly. Further, the insulating member may be formed in the shape and/or size corresponding to a surface of the electrode assembly facing the cap assembly. Accordingly, the insulating member may provide electrical insulation between the electrode assembly and the case.

The insulating member may include a first through-hole 512, a second through-hole 514, and a third through-hole 516. The first current collection tab and the second current collection tab may be inserted through the first through-hole 512 and the second through-hole 514, respectively, and thereby pass through the insulating member. The third through-hole 516 may serve as a passage for smooth injection of the electrolyte solution into the secondary battery. The third through-hole 516 may be formed in the center of the insulating member, but the present disclosure is not limited to the third through-hole being formed at the center position.

The first through-hole 512 and the second through-hole 514 may be disposed side-by-side and spaced apart from each other in the first direction (X-axis). The width of the first through-hole 512 in the first direction (X-axis) may correspond to the width of the first current collection tab. Accordingly, the first current collection tab may pass through the insulating member via the first through-hole 512. Similarly, the width of the second through-hole 514 in the first direction (X-axis) may correspond to the width of the second current collection tab. Accordingly, the second current collection tab may pass through the insulating member via the second through-hole 514.

According to embodiments, the first through-hole 512 and the second through-hole 514 may be positioned more towards one side with respect to the center line of the insulating member in the second direction (Y-axis). For example, the first through-hole 512 and the second through-hole 514 may be disposed at the upper side or the lower side with respect to the center line of the insulating member in the second direction (Y-axis). With such a configuration, a surface of the current collection tab that passes through the insulating member is disposed in contact with the electrode terminal and/or the case, thereby ensuring a welding space between the current collection tab and the electrode terminal and/or the case.

FIG. 5 illustrates the third through-hole 516 as having a circular shape. But the present disclosure is not limited to such a shape, and the shape of the third through-hole 516 may be appropriately changed. In addition, the size, position, number, etc. of the third through-hole 516 may be appropriately changed.

Referring to FIG. 6, the insulating member may include a first through-hole 612, a second through-hole 614, a third through-hole 616, and a fourth through-hole 618. The first current collection tab and the second current collection tab may be inserted through the first through-hole 612 and the second through-hole 614, respectively, to thereby pass through the insulating member. The first through-hole 612 and the second through-hole 614 may be disposed side-by-side and spaced apart from each other in the first direction (X-axis). The first through-hole 612 and the second through-hole 614 may also be positioned more towards one side with respect to the center line of the insulating member in the second direction (Y-axis). The third through-hole 616 and the fourth through-hole 618 may serve as a passage for injection of the electrolyte solution into the secondary battery. The fourth through-hole 618 may be additionally formed for electrolyte injection.

FIG. 6 illustrates that the third through-holes 616 and fourth through-holes 618, which are circular, are disposed in a row. But the present disclosure is not limited to such a configuration, and the shape, size, arrangement of third through-holes 616 and the fourth through-holes 618 may be appropriately changed. The number of third through-holes 616 and fourth through-holes 618 is also not limited to the number illustrated and may be appropriately changed, for example, to the achieve smoothness in electrolyte injection.

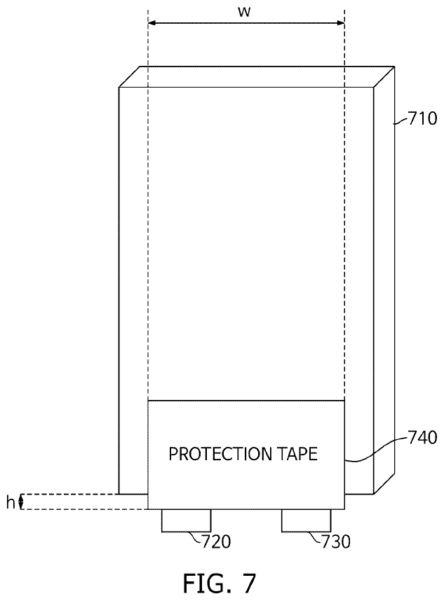

FIG. 7 is a diagram of a protection tape 740 according to embodiments of the present disclosure.

According to embodiments, an electrode assembly 710 may include a first current collection tab 720 and a second current collection tab 730 each protruding from a side of the electrode assembly 710 and spaced apart from each other by a certain distance.

According to embodiments, the protection tape 740 may be attached to a surface of the electrode assembly 710. In particular, the protection tape 740 may be attached to a surface of the electrode assembly 710 that faces a case cover when the electrode assembly 710 is inserted into a case. According to embodiments, the material of the protection tape 740 may be formed of polypropylene (PP), polyimide (PI), etc., but the present disclosure is not limited to such examples. Accordingly, the protection tape 740 may prevent the electrode assembly 710 from being in contact with the case or the case cover in a state of being inserted into the case.

A width w of the protection tape 740 may be long enough to cover both the first current collection tab 720 and the second current collection tab 730. As a specific example, the width w of the protection tape 740 may be formed to a length to cover the first current collection tab 720 and the second current collection tab 730 that are spaced apart by a certain distance. For example, the width w of the protection tape 740 may be equal to or greater than a sum of the width of the first current collection tab 720, the width of the second current collection tab 730, and the separation distance between the first current collection tab 720 and the second current collection tab 730.

As another example, the protection tape 740 may be provided with two pieces, with one of the pieces covers the first current collection tab 720 and the other piece covering the second current collection tab 730. In this case, the width w of each of the two protection tapes 740 may be determined to be long enough to cover one of the first current collection tab 720 and the second current collection tab 730. For example, the width of the first protection tape may be equal to or greater than the width of the first current collection tab 720, and the width of the second protection tape may be equal to or greater than the width of the second current collection tab 730.

According to embodiments, the protection tape 740 may be attached to the electrode assembly 710 so as to protrude a certain length in the same direction that the first current collection tab 720 protrudes from the electrode assembly. The protruding length h of the protection tape 740 may be adjusted so that the protection tape 740 does not interfere with the welding area when the electrode assembly 710 is inserted into the case and the case and the case cover are joined together by welding.

FIG. 7 is an example of the protection tape 740 being attached to the electrode assembly 710, but the method of attaching the protection tape 740 is not limited thereto. For example, the protection tape 740 may be attached to the inner surface of the case cover. In such a configuration, the width w of the protection tape 740 may be formed to cover the first current collection tab 720 and the second current collection tab 730, as described above. In addition, the attachment position of the protection tape 740 a position that protrudes further than the end of the electrode assembly 710 where the current collection tab is formed when the electrode assembly 710 is inserted into the case and the case cover are joined.

The protection tape 740 may prevent the first current collection tab 720 and/or the second current collection tab 730, which are bent during the process of accommodating the electrode assembly 710 in the case, from coming into contact with the case or the case cover. Thus, it is possible to prevent a short-circuit from occurring by the first current collection tab 720, which has a positive polarity, coming into contact with the case or the case cover, which has a negative polarity.

FIGS. 8 to 10 are diagrams for describing a method of manufacturing a secondary battery according to embodiments of the present disclosure. FIG. 8 illustrates an example of a method of joining a first current collection tab 820 to an electrode terminal 850. The electrode assembly 810 may have a structure in which positive electrode plates and negative electrode plates in the form of sheets are alternately stacked with separators therebetween. Positive electrode base tabs that are electrically connected to positive electrode uncoated portions may be formed on one side of each of the positive electrode plates, and the positive electrode base tabs may be joined to each other to form the first current collection tab 820. Although not illustrated in FIG. 8, negative electrode base tabs that are electrically connected to negative electrode uncoated portions may be formed on one side of the negative electrode plates, and the negative electrode base tabs may be joined to each other to form the second current collection tab. The first current collection tab 820 and the second current collection tab may be formed by welding, but the present disclosure is not limited thereto.

The first current collection tab 820 may be inserted through a first through-hole formed in an insulating member 830 to thereby pass through the insulating member 830. Similarly, the second current collection tab may be inserted through a second through-hole formed in the insulating member 830 to thereby pass through the insulating member 830. The insulating member 830 may have an adhesive layer formed on its surface facing the electrode assembly 810, and the insulating member 830 through which the first current collection tab 820 and the second current collection tab pass may be attached to the electrode assembly 810.

The first through-hole and the second through-hole formed in the insulating member 830 may be positioned more towards one direction by a certain length with respect to the center line. In addition, the first current collection tab 820 and the second current collection tab may be formed to be positioned more towards one side with respect to the stacking direction of the electrode assembly 810. Accordingly, the position of each current collection tab corresponds to a position of one of the through-holes such that the current collection tabs may easily pass through the insulating member.

The first current collection tab 820 passing through the insulating member 830 may be directly connected to the electrode terminal 850 that passes through the case 840. The electrode terminal 850 may be formed to protrude form a surface of the case 840, and an opening may be formed on an opposite surface of the case 840 that is faces the electrode terminal 850. Accordingly, the first current collection tab 820 may be connected to the electrode terminal 850 that passes through the opening in the case 840. Similarly, the second current collection tab may be disposed on the inner surface of one side of the case 840 where the electrode terminal 850 passes through an opening.

The first current collection tab 820 connected to the electrode terminal 850 may be joined to the electrode terminal 850. In addition, the second current collection tab connected to a side of the case 840 may be joined to the inner surface of the side of the case 840.

A protection tape 860 may be attached toa surface of the electrode assembly 810. The protection tape 860 may be attached to the surface of the electrode assembly 810 that faces the opening in the case 840 through which the electrode assembly 810 is inserted into the case 840. The protection tape 860 may be attached to the case cover.

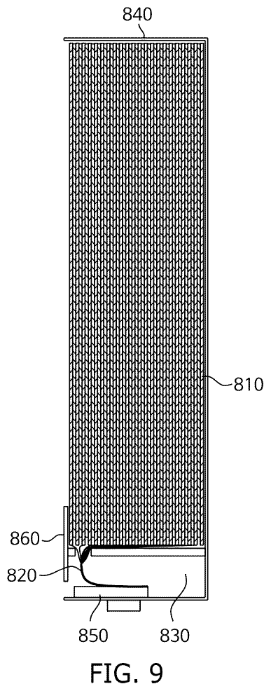

FIG. 9 illustrates an example of a method of accommodating the electrode assembly 810 in the case 840. The electrode assembly 810 may be rotationally inserted into the case 840. For example, the electrode assembly 810 may be inserted into the case 840 by being rotated by 90 degrees as in a motion of the electrode assembly 810 from the position shown in FIG. 8 to the position of the electrode assembly shown in FIG. 9. As the electrode assembly 810 is rotated, the first current collection tab 820 joined to the electrode terminal 850 and the second current collection tab joined toa surface of the case 840 may each be bent. Before rotating the electrode assembly 810, a surface of the current collection tab that passes through the insulating member placed in contact with the electrode terminal 850 and/or the case 840 so that a welding space for joining the current collection tab and the electrode terminal 850 and/or the case 840 may be ensured. After ensuring the welding space and performing welding, the electrode assembly 810 may be rotated and inserted into the case so that the space inside the case 840 is efficiently utilized.

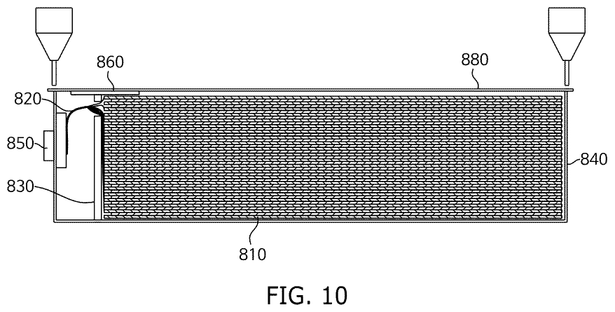

FIG. 10 illustrates an example of a method of sealing the case 840 by joining a case cover 880 to the case 840. After the electrode assembly 810 is inserted into the case 840, the case cover 880 may be welded along the circumference of the opening in the case 840.

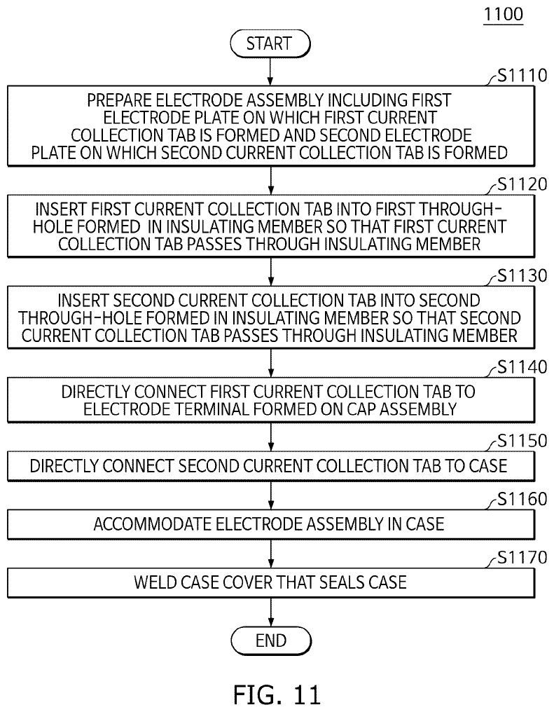

FIG. 11 is a flowchart 1100 for describing a method of manufacturing a secondary battery according to embodiments of the present disclosure. The method of manufacturing the secondary battery may begin with preparing an electrode assembly including one or more first electrode plates, with a first current collection tab being formed on each first electrode plate, and one or more second electrode plates, with a second current collection tab being formed on each second electrode plate (step S1110). The electrode assembly may further include one or more separators, and the electrode assembly may be formed by alternately stacking a first electrode plate and a second electrode plate with a separator between the first and second electrode plates.

The preparing of the electrode assembly may include forming a first current collection tab by joining a plurality of first base tabs that protrude toward a side of the first electrode plate, and forming a second current collection tab by joining a plurality of second base tabs that protrude toward a side of the second electrode plate.

Next, the first current collection tab may be inserted into a first through-hole formed in an insulating member so that the first current collection tab passes through the insulating member (step S1120). The second current collection tab may be inserted into a second through-hole formed in the insulating member so that the second current collection tab passes through the insulating member (step S1130).

Then, the first current collection tab may be directly connected to an electrode terminal formed on a cap assembly (step S1140) and the second current collection tab may be directly connected to a case (step S1150). The cap assembly may be formed on one surface of the case, and the case may have an opening on a side that perpendicular to the side where the cap assembly is formed. Accordingly, the electrode assembly may be inserted into the case through the opening.

The direct connection of the first current collection tab to the electrode terminal formed in the cap assembly may include disposing the first current collection tab on the electrode terminal by the first current collection tab passing through an opening in an insulating member. The direct connection of the second current collection tab to the case may include disposing the second current collection tab on a surface of the case by the second current collection tab passing through an opening in the insulating member. Thereafter, the insulating member and the electrode assembly may be bonded to each other.

Then, the electrode assembly may be accommodated in the case (step S1160). The accommodating of the electrode assembly in the case may include bending the first current collection tab and the second current collection tab as the electrode assembly is rotated into the case. Finally, the case cover that seals the case may be joined by welding (step S1170).

Although the present disclosure has been described above with respect to embodiments thereof, the present disclosure is not limited thereto. Various modifications and variations can be made thereto by those skilled in the art within the spirit of the present disclosure.

### DESCRIPTION OF SOME REFERENCE SYMBOLS

110: electrode assembly
120: first current collection tab
130: second current collection tab
140: case
150: electrode terminal
160: insulating member
170: cap assembly

What is claimed is:

1. A secondary battery comprising:
an electrode assembly comprising a first electrode plate on which a first current collection tab is formed and a second electrode plate on which a second current collection tab is formed;
a case accommodating the electrode assembly;
a cap assembly formed at a side of the case; and
an insulating member disposed between the cap assembly and the electrode assembly,
wherein the first current collection tab is directly connected to an electrode terminal that passes through the cap assembly, and
wherein at least one of the first current collection tab and the second current collection tab passes through the insulating member.

2. The secondary battery as claimed in claim 1, wherein the second current collection tab is directly connected to the case, and
wherein the first current collection tab and the second current collection tab pass through the insulating member.

3. The secondary battery as claimed in claim 2, wherein an opening is formed in the case on a side that is perpendicular to the side where the cap assembly is formed, and
wherein the electrode assembly is inserted into the case through the opening.

4. The secondary battery as claimed in claim 1, wherein the first electrode plate comprises a plurality of the first electrode plate and a plurality of first base tabs protruding toward a side of the first electrode plates,
wherein the second electrode plate comprises a plurality of the second electrode plate and a plurality of second base tabs protruding toward a side of the second electrode plates,
wherein the first current collection tab is formed by joining the first base tabs, and
wherein the second current collection tab is formed by joining the second base tabs.

5. The secondary battery as claimed in claim 2, wherein the insulating member comprises a first through-hole and a second through-hole,
wherein the first current collection tab passes through the insulating member via the first through-hole, and
wherein the second current collection tab passes through the insulating member via the second through-hole.

6. The secondary battery as claimed in claim 5, wherein the first through-hole and the second through-hole are disposed side-by-side and spaced apart from each other in a first direction, and
wherein the first through-hole and the second through-hole are disposed more towards one side with respect to a center line in a second direction perpendicular that is to the first direction.

7. The secondary battery as claimed in claim 1, wherein an adhesive layer is formed on one surface of the insulating member, and
wherein the insulating member and the electrode assembly are bonded to each other by the adhesive layer.

8. The secondary battery as claimed in claim 5, wherein the insulating member has a third through-hole for injection of an electrolyte into the case.

9. The secondary battery as claimed in claim 3, further comprising:
a case cover joined to the case and sealing the opening; and
a protection tape attached to a surface of the electrode assembly and facing the case cover.

10. The secondary battery as claimed in claim 9, wherein the protection tape protrudes from the electrode assembly in a direction that the first current collection tab protrudes from the electrode assembly.

11. The secondary battery as claimed in claim 3, further comprising:
a case cover joined to the case and sealing the opening; and
a protection tape attached to a surface of the case cover and facing the electrode assembly.

12. The secondary battery as claimed in claim 1, wherein the electrode assembly further comprises separators, and
wherein the electrode assembly is formed by alternately stacking a plurality of the first electrode plate and a plurality of the second electrode plate with the separators between each adjacent first plate and the second plate.

13. A method of manufacturing a secondary battery, the method comprising:
preparing an electrode assembly comprising a first electrode plate on which a first current collection tab is formed and a second electrode plate on which a second current collection tab is formed;
inserting the first current collection tab through a first through-hole formed in an insulating member so that the first current collection tab passes through the insulating member;
inserting the second current collection tab through a second through-hole formed in the insulating member so that the second current collection tab passes through the insulating member;
directly connecting the first current collection tab to an electrode terminal provided on the cap assembly;
directly connecting the second current collection tab to a case;
accommodating the electrode assembly in the case; and
joining a case cover to the case by welding to thereby seal the case.

14. The method as claimed in claim 13, wherein the preparing of the electrode assembly comprises:
forming the first current collection tab by joining a plurality of first base tabs protruding from a side of the first electrode plate; and
forming the second current collection tab by joining a plurality of second base tabs protruding from a side of the second electrode plate.

15. The method as claimed in claim 13, wherein the cap assembly is formed at a side of the case,
an opening is formed in a side of the case that is perpendicular to the side where the cap assembly is formed, and
wherein the electrode assembly is inserted into the case through the opening.

16. The method as claimed in claim 15, wherein the direct connecting of the first current collection tab to the electrode terminal provided on the cap assembly comprises disposing the first current collection tab on the electrode terminal.

17. The method as claimed in claim 15, wherein the direct connecting of the second current collection tab to the case comprises disposing the second current collection tab on the surface of the case.

18. The method as claimed in claim 15, wherein the accommodating of the electrode assembly in the case comprises rotating the electrode assembly into the case, with the first current collection tab and the second current collection tab being bent as the electrode assembly is rotated.

19. The method as claimed in claim 13, further comprising bonding the insulating member to the electrode assembly before accommodating of the electrode assembly in the case.

20. The method as claimed in claim 13, wherein the electrode assembly further comprises separators, and
wherein the electrode assembly is formed by alternately stacking a plurality of the first electrode plate and a plurality of the second electrode plate with the separators between each adjacent first plate and the second plate.
